(19) United States
(12) Patent Application Publication
(10) Pub. No.: US 2025/0272760 A1
(43) Pub. Date: Aug. 28, 2025

(54) INDIRECT TAX LEGISLATION FILTER

(71) Applicant: Vertex, Inc., King of Prussia, PA (US)

(72) Inventors: Brian Stevenson, Media, PA (US); Brian Sparks, Houston, TX (US)

(21) Appl. No.: 18/584,719

(22) Filed: Feb. 22, 2024

(51) Int. Cl. G06Q 40/10; G06Q 50/18

(52) U.S. Cl. CPC G06Q 40/10; G06Q 50/18

(57) ABSTRACT

A computing system for filtering indirect tax legislation includes processing circuitry that implements an indirect tax legislation filtering program. The processing circuitry imports customer sales tax calculation history data from a customer sales tax calculation history database, imports customer configuration data from a customer configuration database, and generates a product category report indicating taxable products sold by a customer. New and/or changed tax rules from the monthly data update are imported, and, in response to receiving an instruction to identify products affected by a monthly data update of indirect tax rule changes, the product category report is filtered with the monthly data update of the tax rule changes. A legislative change report indicating product categories and associated products affected by the tax rule changes is generated and output.

### BACKGROUND

Federal, state, and municipal governments and government agencies frequently issue tax rule changes in accordance with evolving tax policies, thereby affecting indirect taxes. These tax rule changes, which often number from hundreds to tens of thousands, contain various tax rates and effective dates. Companies that sell goods and/or services are required to adopt these tax rule changes in timely manner or face a consequence of inappropriately calculating tax. As a downstream impact, the companies can be financially obligated to make up any funding difference between the taxes collected and the taxes owed to a jurisdiction. Moreover, in the case of an overcollection, the company may be subject to disciplinary actions such as audits, penalties, and interest. Sorting through the new tax rule changes is burdensome and time-consuming for tax professionals. As such, a challenge exists in efficiently identifying new tax rule changes that are materially relevant to individual clients.

### SUMMARY

To address these issues, a computer system for filtering indirect tax legislation is provided. According to one aspect, the computing system comprises a computing device including processing circuitry configured to execute instructions using portions of associated memory to implement an indirect tax legislation filtering program. Customer sales tax calculation history data is imported from a customer sales tax calculation history database, and customer configuration data is imported from a customer configuration database. The processing circuitry generates a product category report indicating taxable products sold by a customer. New and/or changed tax rules from the monthly data update are imported, and, in response to receiving an instruction to identify products affected by a monthly data update of indirect tax rule changes, the product category report is filtered with the monthly data update of the tax rule changes. A legislative change report indicating product categories and associated products affected by the tax rule changes is generated and output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view showing a computing system for filtering indirect tax legislation, according to an example implementation.

FIG. 2 is an example graphical user interface displaying a legislative change report summary generated by the computing system of FIG. 1.

FIG. 3 is an example graphical user interface displaying jurisdiction details for a product or product category affected by tax rule changes, generated by the computing system of FIG. 1.

FIG. 4 is an example an example graphical user interface displaying tax rule details, generated by the computing system of FIG. 1.

FIG. 5 shows a flowchart for a method for filtering indirect tax legislation.

FIG. 6 shows a schematic view of an example computing environment in which the computing system of FIG. 1 may be enacted.

### DETAILED DESCRIPTION

Taxes are levied on numerous products, such as the production, extraction, sale, transfer, leasing, and/or delivery of goods, the rendering of services, and on the use of goods or permission to use goods or to perform activities. Examples of indirect taxes applied to the sale of goods and services include sales tax, excise tax, value-added tax (VAT), and goods and services tax (GST). As discussed above, determining which products of each customer are affected by monthly tax rule changes can be time-consuming. Failure to adopt the tax rule changes, whether due to time constraints or human error, may result in financial penalties and loss of customers. As such, there exists a need for the accurate and expeditious filtering of tax rule changes.

Taxes are levied on numerous products, such as the production, extraction, sale, transfer, leasing, and/or delivery of goods, the rendering of services, and on the use of goods or permission to use goods or to perform activities. Examples of indirect taxes applied to the sale of goods and services include sales tax, excise tax, value-added tax (VAT), and goods and services tax (GST). As discussed above, determining which products of each customer are affected by monthly tax rule changes can be time-consuming. Failure to adopt the tax rule changes, whether due to time constraints or human error, may result in financial penalties and loss of customers. As such, there exists a need for the accurate and expeditious filtering of tax rule changes.

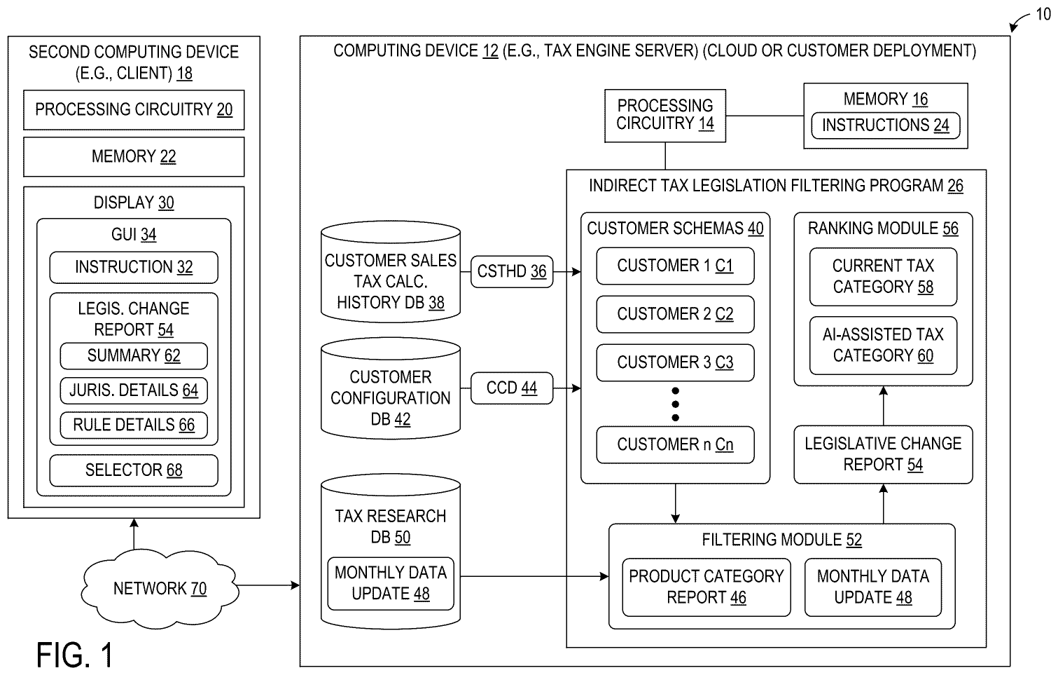

To address the issues described above, a computing system 10 for filtering indirect tax legislation is provided. Referring initially to FIG. 1, the computing system 10 includes at least one computing device. The computing system 10 is illustrated as having a first computing device 12 including processing circuitry 14 and memory 16, and a second computing device 18 including processing circuitry 20 and memory 22. The illustrated implementation is exemplary in nature, and other configurations are possible. In the description below, the first computing device will be described as a tax engine server 12 and the second computing device will be described as a client computing device 18, and respective functions carried out at each device will be described. It will be appreciated that in other configurations, the computing system 10 may include a single computing device that carries out the salient functions of both the server 12 and client computing device 18, and that the first computing device could be a computing device other than server. In other alternative configurations, functions described as being carried out at the server 12 may alternatively be carried out at the client computing device 18 and vice versa.

Continuing with FIG. 1, the processing circuitry 14 is configured to execute instructions 24 using portions of associated memory 16 to implement an indirect tax legislation filtering program 26 hosted at the tax engine server 12. At a high level, the indirect tax legislation filtering program 26 is configured to process a tax legislation monthly data update in view of a customer's sales tax history, tax configuration, and products, and output a legislative change report detailing any products in the customer's portfolio that are affected by tax rule changes in the monthly data update. It will be appreciated that the term “product” as used herein may refer to goods, such as tangible products and digital products, as well as services.

The processing circuitry 14 periodically imports customer sales tax calculation history data 36 from a customer sales tax calculation history database 38. The customer sales tax calculation history database 38 may receive comma separated value (CSV) files including, but not limited to, sales tax and seller use tax on products sold by the customer. The CSV files are converted to optimized row columnar (ORC) files, which are imported to a table in a customer schema 40 as semi-structured sales tax calculation history data 36. The data is then transformed for simplified reporting of data elements. It will be appreciated that the indirect tax legislation filtering program 26 may include customer schemas 40 for a plurality of customers C1, C2, C3 . . . . Cn. The customer schemas 40 are unique to each customer and include information such as product codes, tax categories, tax types, tax jurisdictions, and currently applied tax rules, for example.

To determine a configuration for the customer, customer configuration CSV files are unzipped and imported into staging tables in a customer configuration database 42. A transformation is run to organize the customer's mappings of general tax categories to specific products and product groups, and customer configuration data 44 is distributed to the customer's schema 44. A product category report 46 is generated for each customer from a respective customer schema 44, the product category report 46 indicating taxable products sold by that customer.

In parallel to importing the customer sales tax history data 36 and the customer configuration data 40, new and/or changed tax rules from the monthly data update 48 are imported from a tax research database 50. The monthly data update 48 contains a full list of tax rule changes introduced during a time period that is selectable in the GUI 34. The tax rule changes may be new taxes, changes to existing tax rates, tax holidays, new or changed qualifying conditions, and the like, for example. Additionally, the monthly data update 48 may contain tax rule changes that are effective immediately, as well as tax rule changes that take effect at a future date. Each change includes the jurisdiction, the category effected, and the effect on taxation.

The client computing device 18 includes a graphical user interface (GUI) 28 that is displayed on a display 30 and configured to accept an instruction 32 to identify products affected by a monthly data update of indirect tax rule changes. As described below, the instruction 32 is input by a user, such as a tax professional, via a graphical user interface (GUI) 34 displayed on the display 30. The instruction 32 may be sent from the client computing device 18 to the tax engine server 12 as an instruction to determine the impact of the tax rule changes on the tax categories and products for a specific customer.

In response to the receiving the instruction 32, the processing circuitry 14 of the tax engine server 12 executes a query to filter the product category report 46 with the monthly data update 48 of tax rule changes in a filtering module 52. In a first step of filtering, the full list of legislative changes in the monthly data update 48 for the selected time period is joined by tax category to the customer configuration data 40 to identify a subset of the full list of products and product groupings that apply to the customer. Next, the tax rule changes are joined by product and/or product grouping, jurisdiction, and a configurable prior date range, such as the prior month, to the sales tax or seller's use history data to determine total dollars in sales and tax in that prior date range.

A legislative change report 54 is then generated, indicating the product categories and associated products that are affected by the tax rule changes in the monthly data update 48. The results of the legislative change report 54 are ranked in a ranking module 56 by total sales descending to highlight the tax rule changes that have the potential to be the most impacting to the customer. It will be appreciated that, in some implementations, the product categories may be ranked according to a current tax category assignment 58. In other implementations, the product categories may be ranked according to an artificial intelligence-assisted tax category assignment 60.

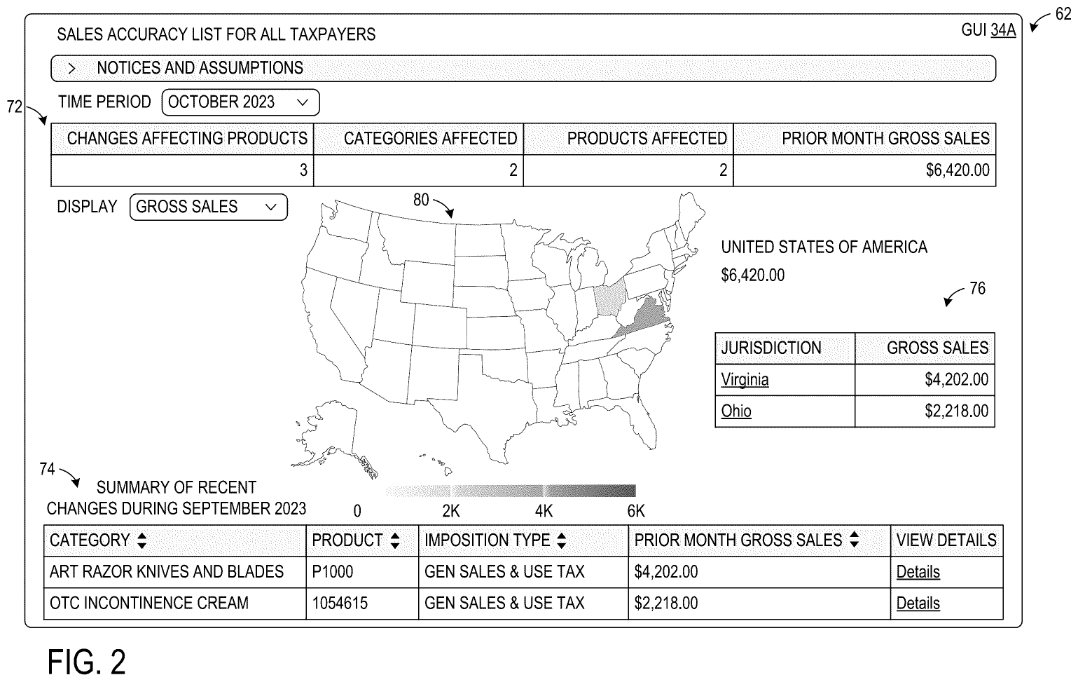

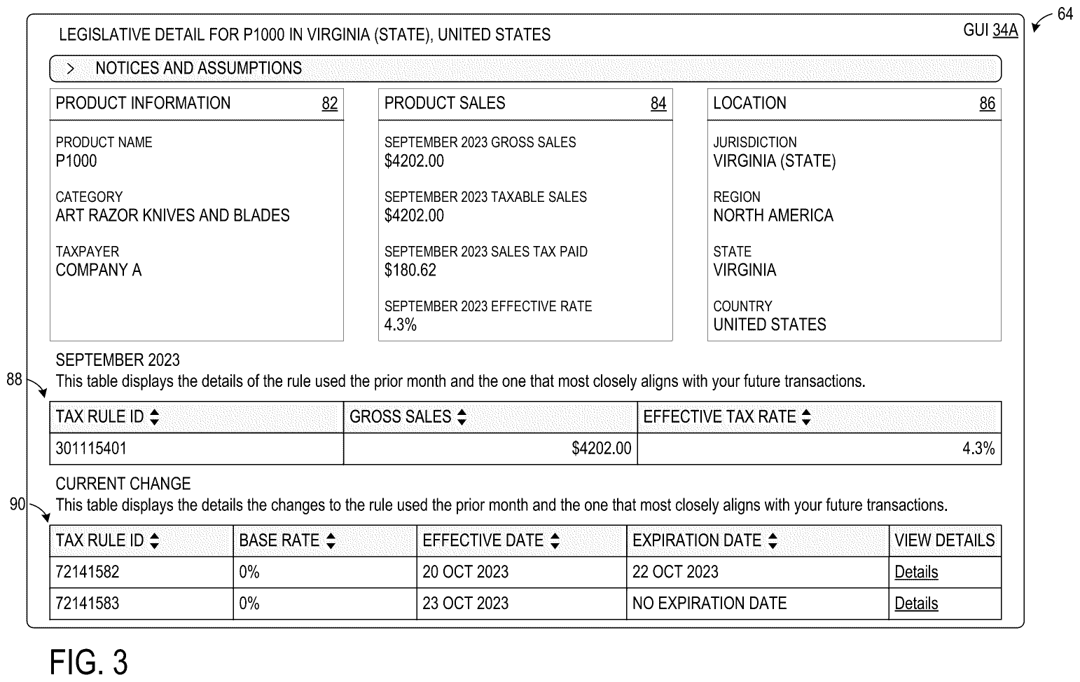

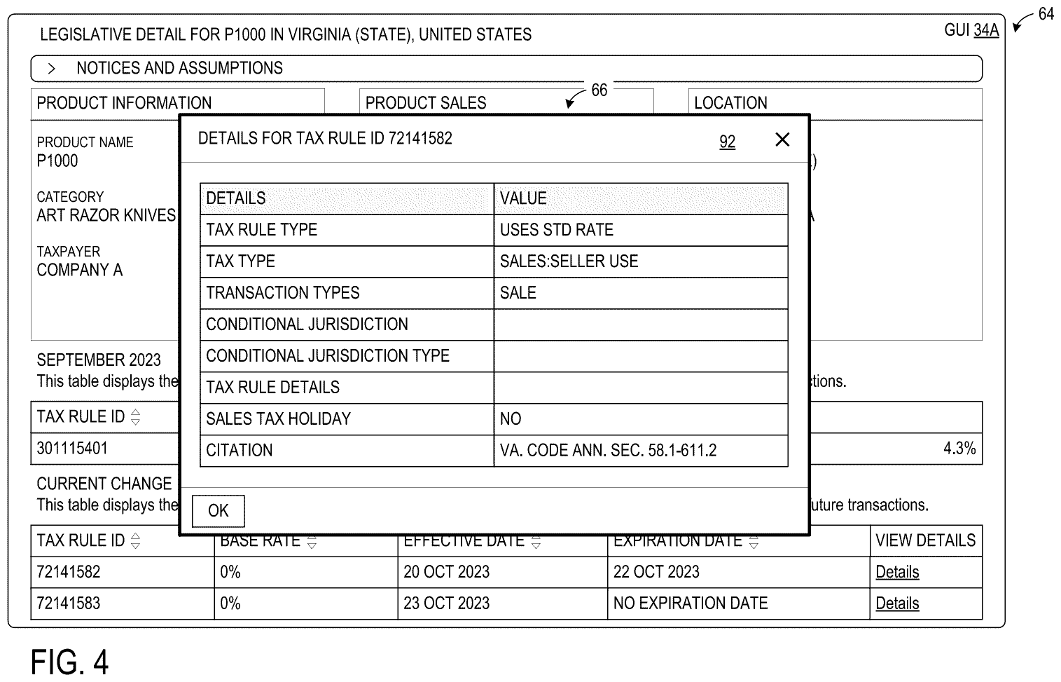

The legislative change report 54 is then output from the tax engine server 12 and may be displayed in the GUI 34 of the client computing device 18. As shown in FIG. 2, the legislative change report 54 may be viewed as a summary 62 of the product categories and associated products affected by the tax rule changes and respective jurisdictions in which the associated products are sold. As discussed below with respect to FIGS. 3 and 4, in addition to the legislative change summary 62, the user can also opt to display a jurisdiction detail view 64 for a product or product category affected by tax rule changes, as well as a tax rule detail view 66 in the legislative change report 54. The GUI 34 may also include a selector 68 that permits the user to adopt or reject a suggested tax category change triggered by the results of the legislative change report 54. It will be appreciated that the tax engine server 12 is connected to the client computing device 18 via a network 70.

Turning to FIG. 2, an example GUI 34A displaying a legislative change report summary 62 is shown. In the illustrated example, the selected time period is the month of October 2023. An overview 72 of the changes affecting products, categories affected, products affected, and the prior month gross sales are displayed. In the example in FIG. 2, the indirect tax legislation filtering program 26 identified two products, P1000 and 1054615, that are affected by the tax rule changes, and would likely impact the customer. In a summary of recent changes for the prior month 74, the product category that is most impacted by a tax rule change, based on September sales in that category, is at the top. In a jurisdiction summary 76, the jurisdictions, Virginia and Ohio, in which the affected products are sold are displayed, along with the corresponding gross monthly sales for the previous month for those products. This information is also conveyed visually via a map 80, in which the impacted jurisdictions are highlighted according to a scale of impact by gross sales. As indicated by the underlined state names in the jurisdiction summary, each jurisdiction shown in the legislative change report summary 62 may be selected to display a jurisdiction detail view 64 with further details of a tax rule change that impacts a product sold in a specific jurisdiction.

Continuing with the example shown in FIG. 2, FIG. 3 illustrates the GUI 34A displaying jurisdiction details 64 of the tax rule change that affects the product P1000 sold in Virginia. displaying jurisdiction details for a product or product category affected by tax rule changes. As shown, product information 82, product sales 84, and location 86 of the product sales are displayed in the jurisdiction details 64. The product information 82 may include the product name, the tax category, and the client, e.g., company, that pays indirect taxes on the product. The product sales 84 may include the gross and taxable sales for the previous month, the sales tax paid in the previous month, and the effective tax rate for the previous month. The location 86 may show the jurisdiction, region, state, and country in which the product is sold. The details of the tax rule applied to the product in the previous month are shown in table 88, and the details of the tax rule changes are shown in table 90. As with the jurisdiction summary in which each jurisdiction may be selected to view further details, a tax rule detail view 66 for each tax rule shown in jurisdiction detail view 64 can be displayed by selecting “details” for the desired tax rule change in table 90.

FIG. 4 shows the example GUI 34A displaying a tax rule detail view 66 for a tax rule that was selected in the jurisdiction detail view 64. The tax rule detail view 66 may be displayed as a table superimposed on the jurisdiction detail view 64. As illustrated, table 92 includes details such as tax rule type, tax type, transaction types, conditional jurisdiction, conditional jurisdiction type, tax rule details, sales tax holiday, and a citation to the legislation that caused the change.

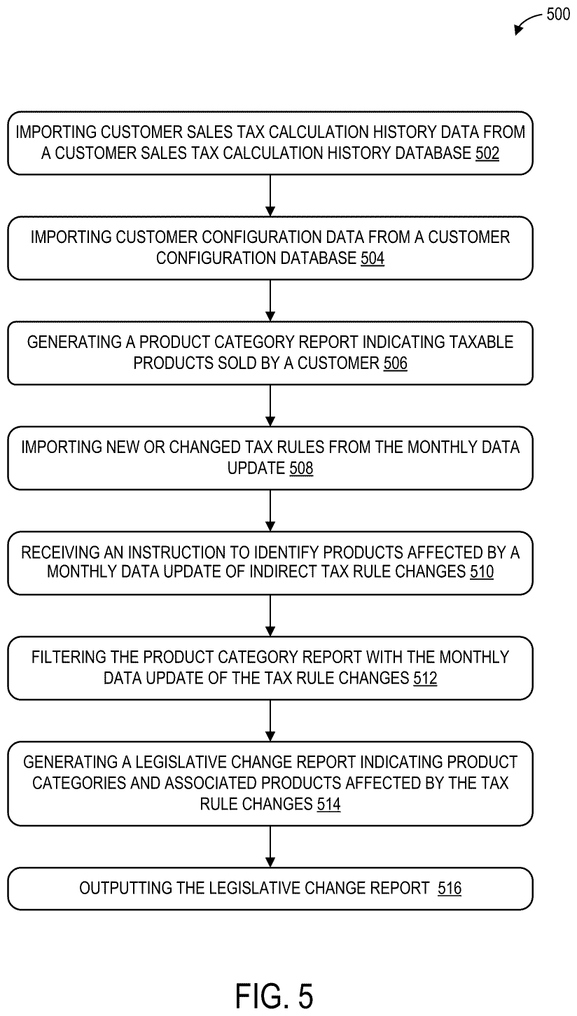

FIG. 5 shows a flowchart for a method 500 for filtering indirect tax legislation. The method 500 may be implemented by the computing system 10 illustrated in FIG. 1, or via other suitable hardware and software.

At step 502, the method 500 may include importing customer sales tax calculation history data from a customer sales tax calculation history database. The customer sales tax calculation history database may receive CSV files including, but not limited to, sales tax and seller use tax on products sold by the customer. The CSV files may be converted to ORC files, which are imported to a table in a customer schema as semi-structured sales tax calculation history data. The data may then be transformed for simplified reporting of data elements. The customer schema may include information such as product codes, tax categories, tax types, tax jurisdictions, and currently applied tax rules, for example.

Continuing from step 502 to step 504, the method 500 may include importing customer configuration data from a customer configuration database. To this end, customer configuration CSV files may be unzipped and imported into staging tables in a customer configuration database. The customer's mappings of general tax categories to specific products and product groups may be organized, and customer configuration data may be distributed to the customer's schema. Advancing from step 506 to step 508, the method 500 may include generating a product category report indicating taxable products sold by the customer.

Proceeding from step 504 to step 506, the method 500 may include importing new and/or changed tax rules from the monthly data update. The monthly data update contains a full list of tax rule changes, which may be new taxes, changes to existing tax rates, tax holidays, new or changed qualifying conditions, and the like, for example. Each change includes the jurisdiction, the category effected, and the effect on taxation.

Continuing from step 508 to step 510, the method 500 may include receiving an instruction to identify products affected by a monthly data update of indirect tax rule changes. The instruction may be input by a user, such as a tax professional, via GUI displayed on a display of a client computing device. The instruction may be sent from the client computing device to a tax engine server as an instruction to determine the impact of the tax rule changes on the tax categories and products for a specific customer.

Proceeding from step 510 to step 512, the method 500 may include filtering the product category report with the monthly data update of the tax rule changes. First, the full list of legislative changes in the monthly data update for a selected time period may be joined by tax category to the customer configuration data to identify a subset of the full list of products and product groupings that apply to the customer. Next, the tax rule changes may be joined by product and/or product grouping, jurisdiction, and a configurable prior date range, such as the prior month, to the sales tax or seller's use history data to determine total dollars in sales and tax in that prior date range.

Advancing from step 512 to step 514, the method 500 may include generating a legislative change report indicating product categories and associated products affected by the tax rule changes. The results of the legislative change report may be ranked by total sales descending to highlight the tax rule changes that have the potential to be the most impacting to the customer. The product categories may be ranked according to a current tax category assignment and/or according to an artificial intelligence-assisted tax category assignment.

Continuing from step 514 to step 516, the method 500 may include outputting the legislative change report. The legislative change report may be displayed in the GUI of the client computing device and viewed as a summary of the product categories and associated products affected by the tax rule changes and respective jurisdictions in which the associated products are sold. Additionally, the legislative change report may display a jurisdiction detail view for a product or product category affected by tax rule changes, as well as a tax rule detail view. The GUI may include a selector that permits the user to adopt or reject a suggested tax category change triggered by the results of the legislative change report

In some embodiments, the methods and processes described herein may be tied to a computing system of one or more computing devices. In particular, such methods and processes may be implemented as a computer-application program or service, an application-programming interface (API), a library, and/or other computer-program products.

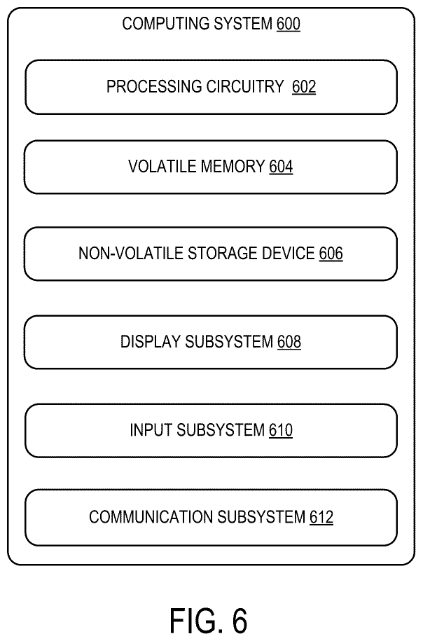

FIG. 6 schematically shows a non-limiting embodiment of a computing system 600 that can enact one or more of the methods and processes described above. Computing system 600 is shown in simplified form. Computing system 600 may embody the computing system 10 described above and illustrated in FIG. 1. Components of computing system 600 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 600 includes processing circuitry 602, volatile memory 604, and a non-volatile storage device 606. Computing system 600 may optionally include a display subsystem 608, input subsystem 6010, communication subsystem 6012, and/or other components not shown in FIG. 6.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 602 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 602.

Non-volatile storage device 606 includes one or more physical devices configured to hold instructions executable by the processing circuitry to implement the methods and processes described herein. When such methods and processes are implemented, the state of non-volatile storage device 606 may be transformed e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by processing circuitry 602 to temporarily store information during processing of software instructions. It will be appreciated that volatile memory 604 typically does not continue to store instructions when power is cut to the volatile memory 604.

Aspects of processing circuitry 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICS), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via processing circuitry 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with processing circuitry 602, volatile memory 604, and/or non-volatile storage device 606 in a shared enclosure, or such display devices may be peripheral display devices.

When included, input subsystem 6010 may comprise or interface with one or more user-input devices such as a keyboard, mouse, touch screen, camera, or microphone.

When included, communication subsystem 6012 may be configured to communicatively couple various computing devices described herein with each other, and with other devices. Communication subsystem 6012 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for filtering indirect tax legislation, the computing system comprising:
a computing device including processing circuitry configured to execute instructions using portions of associated memory to implement an indirect tax legislation filtering program, the processing circuitry being configured to:
import customer sales tax calculation history data from a customer sales tax calculation history database;
import customer configuration data from a customer configuration database;
generate a product category report indicating taxable products sold by a customer;
import new and/or changed tax rules from the monthly data update;
receive an instruction to identify products affected by a monthly data update of indirect tax rule changes;
filter the product category report with the monthly data update of the tax rule changes;
generate a legislative change report indicating product categories and associated products affected by the tax rule changes; and
output the legislative change report.

2. The computing system of claim 1, wherein
the product categories are ranked according to an impact of the tax rule changes in the monthly data update.

3. The computing system of claim 2, wherein
the product categories are ranked according to a current tax category assignment.

4. The computing system of claim 2, wherein
the product categories are ranked according to an artificial intelligence-assisted tax category assignment.

5. The computing system of claim 1, wherein
the legislative change report is displayed in a user interface, the legislative change report including a summary of the product categories and associated products affected by the tax rule changes and respective jurisdictions in which the associated products are sold.

6. The computing system of claim 5, wherein
a jurisdiction detail view for a product affected by the tax rule changes in a respective jurisdiction is selectable from the summary of the legislative change report displayed in a user interface.

7. The computing system of claim 6, wherein
a tax rule detail view is selectable from the jurisdiction details displayed in the user interface.

8. The computing system of claim 1, wherein
the customer sales tax calculation history database receives comma separated value (CSV) files including sales tax and seller use tax on products sold by the customer;
the CSV files are converted to optimized row columnar (ORC) files; and
the ORC files are imported to a table in a customer schema as semi-structured sales tax calculation history data.

9. The computing system of claim 1, wherein
the customer configuration database receives unzipped customer configuration CSV files,
the CSV files are imported into staging tables in the customer configuration database;
mappings of general tax categories to specific products and product groups are organized; and
customer configuration data is distributed to the customer schema.

10. The computing system of claim 1, wherein
a tax rule change is accepted or rejected by the user via a selector included in the user interface.

11. A method for filtering indirect tax legislation, the method comprising, at a computing device implementing an indirect tax legislation filtering program:
importing customer sales tax calculation history data from a customer sales tax calculation history database;
importing customer configuration data from a customer configuration database;
generating a product category report indicating taxable products sold by a customer;
importing new and/or changed tax rules from the monthly data update;
receiving an instruction to identify products affected by a monthly data update of indirect tax rule changes;
filtering the product category report with the monthly data update of the tax rule changes;
generating a legislative change report indicating product categories and associated products affected by the tax rule changes; and
outputting the legislative change report.

12. The method of claim 11, the method further comprising:
ranking the product categories according to an impact of the tax rule changes in the monthly data update.

13. The method of claim 12, the method further comprising:
ranking the product categories according to a current tax category assignment.

14. The method of claim 12, the method further comprising:
ranking the product categories according to an artificial intelligence-assisted tax category assignment.

15. The method of claim 11, the method further comprising:
displaying the legislative change report is displayed in a user interface, the legislative change report including a summary of the product categories and associated products affected by the tax rule changes and respective jurisdictions in which the associated products are sold.

16. The method of claim 15, the method further comprising:
selecting a detailed view of the tax rule changes for a respective jurisdiction from the summary of the legislative change report displayed in a user interface.

17. The method of claim 16, the method further comprising:
selecting a detailed view of a tax rule from the detailed view of tax rule changes for the respective jurisdiction displayed in the user interface.

18. The method of claim 11, the method further comprising:
receiving, at the customer sales tax calculation history database, comma separated value (CSV) files including sales tax and seller use tax on products sold by the customer;
converting the CSV files to optimized row columnar (ORC) files; and
importing the ORC files to a table in a customer schema as semi-structured sales tax calculation history data.

19. The method of claim 11, the method further comprising:
receiving, at the customer configuration database, unzipped customer configuration CSV files,
importing the CSV files into staging tables in the customer configuration database;
organizing mappings of general tax categories to specific products and product groups; and
distributing customer configuration data to the customer schema.

20. A computing system for filtering indirect tax legislation, the computing system comprising:
a computing device including processing circuitry configured to execute instructions using portions of associated memory to implement an indirect tax legislation filtering program, the processing circuitry being configured to:
import customer sales tax calculation history data from a customer sales tax calculation history database;
import customer configuration data from a customer configuration database;
generate a product category report indicating taxable products sold by a customer;
import new and/or changed tax rules from the monthly data update;
receive an instruction to identify products affected by a monthly data update of indirect tax rule changes;
filter the product category report with the monthly data update of the tax rule changes;
rank the product categories according to an impact of the tax rule changes in the monthly data update;
generate a legislative change report indicating product categories and associated products affected by the tax rule;
output the legislative change report;
display the legislative change report in a user interface; and
receive input via a selector in the user interface to accept or reject a tax rule change.
